(19) United States
(12) Patent Application Publication
(10) Pub. No.: US 2006/0055784 A1
(43) Pub. Date: Mar. 16, 2006

(54) Imaging device having image color adjustment function

(75) Inventors: Mari Sugihara, Shinagawa-ku (JP); Tetsuo In, Shinagawa-ku (JP)

Correspondence Address: OLIFF & BERRIDGE, PLC, P.O. BOX 19928, ALEXANDRIA, VA, 22320, US

(73) Assignee: NIKON CORPORATION, Chiyoda-ku (JP)

(21) Appl. No.: 11/213,785

(22) Filed: Aug. 30, 2005

(30) Foreign Application Priority Data
Sep. 2, 2004 (JP) 2004-255922

(51) Int. Cl. H04N 5/225

(52) U.S. Cl. 348/207.99

(57) ABSTRACT

An imaging device according to the present invention includes a registration unit, an imaging unit, a searching unit, and a color adjustment unit. The registration unit registers a reference subject. The imaging unit shoots a subject and outputs image data. The searching unit searches a specific area matching with the reference subject from an image area of the image data. The color adjustment unit performs color adjustment such that color information of the specific area approximates to the color information of the registered reference subject.

### CROSS REFERENCE TO RELATED APPLICATION

This application is based upon and claims the benefit of priority from Japanese Patent Application No. 2004-255922, filed on Sep. 2, 2004, the entire contents of which are incorporated herein by reference.

### BACKGROUND OF THE INVENTION

1. Field of the Invention

The present invention relates to an imaging device which shoots a subject and outputs image data.

2. Description of the Related Art

A conventional technique of applying color adjustment to the image data has been known.

For example, Japanese Unexamined Patent Application Publication No. 2003-32699 (hereinafter, Patent Document 1), discloses the technique of setting in advance a color adjustment value for each of a plurality of representative colors and performing the color adjustment for each representative color.

Moreover, Japanese Unexamined Patent Application Publication No. Hei 10-224647 (hereinafter, Patent Document 2), for example, discloses the technique of applying the color adjustment to moving image data.

However, direct sunlight and shade is different in color temperature. Therefore, if there are portions corresponding to both of direct sunlight and shadow in an image area, unevenness of the color temperature occurs in the image area. In this case, there will be color temperature difference between the portion corresponding to the direct sunlight and the portion corresponding to the shade in a single subject.

Further, at photographing at night or inside the room, the unevenness of color temperature is also likely to occur in the same image area because different kinds of lights such as fluorescent light, bulb, sunlight coming through the window and so on are present in a mixed, complicated manner. Also in this case, the portions of the single subject will have different colors depending on the positions of the portions in the image area.

In case of a moving image, in particular, the unevenness of color temperature and its unnaturalness is very conspicuous because the point at which the color of the subject varies is reproduced as the moving image.

### SUMMARY OF THE INVENTION

In view of the above problems, it is therefore an object of the present invention to realize stable color reproduction of a reference subject while suppressing the influence of unevenness of color temperature in an image area.

Hereinafter, the present invention will be explained.
(1) An imaging device according to the present invention includes an imaging unit, a searching unit and a color adjustment unit. The imaging unit shoots a subject and outputs image data. The searching unit searches from an image area of the image data a specific area similar to a reference subject which is registered in advance. The color adjustment unit applies color adjustment to the image data in such a manner that color information of the specific area approximates to the color information of the registered reference subject.
(2) More preferably, the imaging unit shoots the subject at a predetermined frame rate and outputs moving image data. At this time, the searching unit tracks a found specific area through frames of the moving image data. The color adjustment unit applies the color adjustment to the frames of the moving image data in such a manner that the color information of the specific area does not change among the frames beyond a visually allowable range.
(3) More preferably, the imaging unit outputs moving image data for monitor display which is captured at a predetermined frame rate and still image data for recording which is shot in synchronization with release operation. At this time, the searching unit searches the specific area from the moving image data and tracks the specific area through frames of the moving image data. The searching unit estimates the specific area of the still image data through the tracking. The color adjustment unit obtains color information of the estimated specific area from the still image data or the moving image data. The color adjustment unit applies the color adjustment to the still image data in such a manner that the obtained color information of the specific area approximates to the color information of the registered reference subject.
(4) More preferably, the color adjustment unit applies the color adjustment partially to the specific area.
(5) More preferably, the searching unit includes a registration unit registering the reference subject upon receiving designation of an image of the reference subject among the image data shot by the imaging unit. In this case, the searching unit searches the specific area similar to the image of the reference subject.
(6) More preferably, the searching unit includes a registration unit managing a registration library of the reference subject. In this case, the searching unit searches the specific area similar to the reference subject from the image area of the image data by reading registration information of the reference subject from the registration library. When the specific area is found, the color adjustment unit applies the color adjustment to the image data in such a manner that the color information of the specific area approximates to the color information of the registered reference subject.
(7) More preferably, the imaging device includes a recording unit recording the image data. The recording unit records, as an index of the image data to be recorded, any of an image of the reference subject, an image of the specific area and information on a position of the specific area in the image area.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing an electronic camera 11 of this embodiment;

FIG. 2 is a flowchart (1/2) explaining the operation of this embodiment;

FIG. 3 is a flowchart (2/2) explaining the operation of this embodiment; and

FIG. 4 is a view showing the effect of this embodiment.

### DESCRIPTION OF THE PREFERRED EMBODIMENTS

Hereinafter, a preferred embodiment of the present invention will be explained in detail with reference to the drawings.

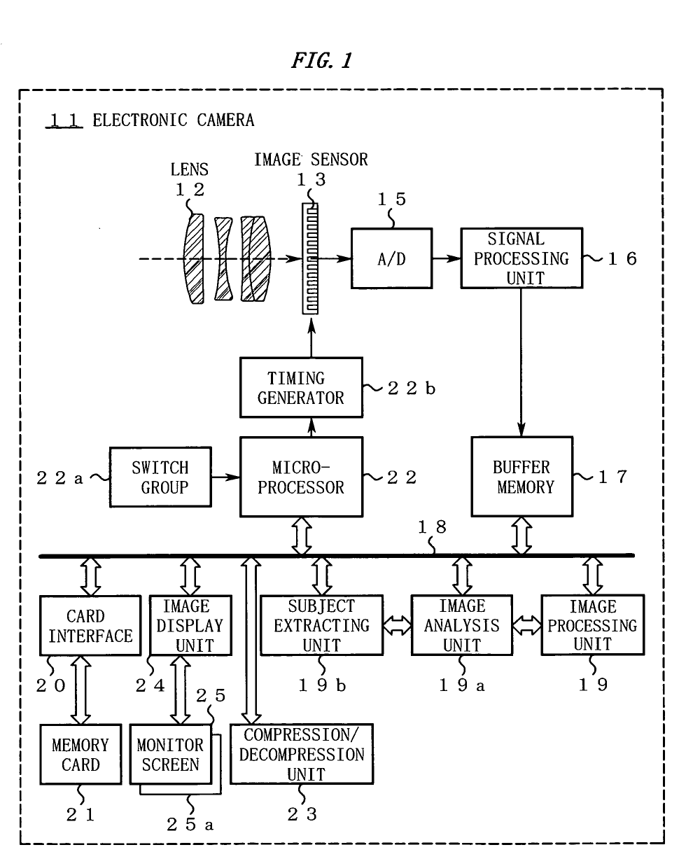

FIG. 1 is a block diagram showing an electronic camera 11 according to this embodiment.

In FIG. 1, the electronic camera 111 is equipped with a lens 12. In an image space of the lens 12, a light-receiving surface of an image sensor 13 is arranged. The operation of the image sensor 13 is controlled by an output pulse of a timing generator 22b.

An image generated by the image sensor 13 is temporarily stored in a buffer memory 17 via an A/D converting unit 15 and a signal processing unit 16.

The buffer memory 18 is connected to a bus 18. To the bus 18, an image processing unit 19, an image analysis unit 19a, a subject extracting unit 19b, a card interface 20, a microprocessor 22, a compression/decompression unit 23, and an image display unit 24 are connected.

Among these, the card interface 20 reads/writes data to/from a detachable memory card 21.

Further, signals are inputted to the microprocessor 22 from a switch group 22a by a user's operation. The switch group 22a includes a release button, a menu button, a mode operation button, a multi-selector button, a command dial and the like. Furthermore, the image display unit 24 displays an image on a monitor screen 25 which is provided on the back surface of the electronic camera 11. A touch panel 25a is provided to the monitor screen 25.

(Explanation of Operation of this Embodiment)

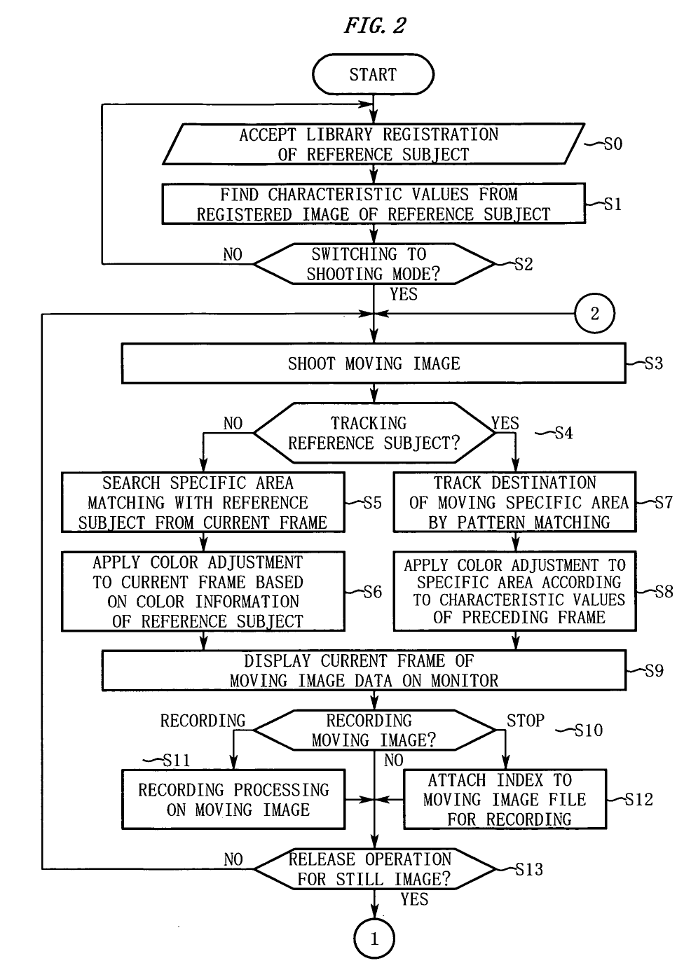

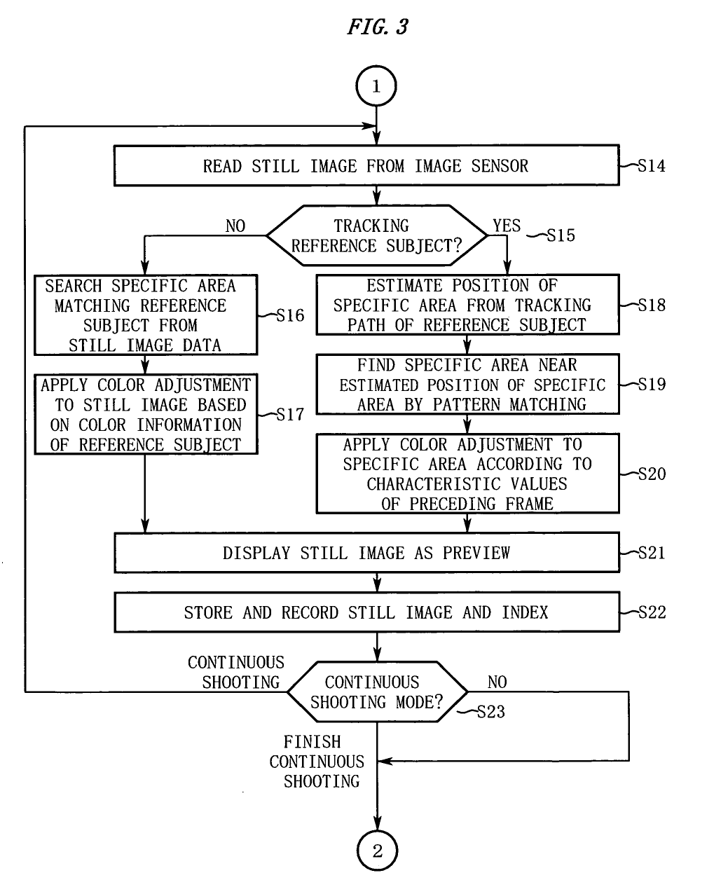

FIG. 2 and FIG. 3 are flowcharts explaining the operation of this embodiment. Hereinafter, the operation of this embodiment will be explained according to step numbers shown in the flowcharts.

Step S0: When the main power supply of the electronic camera 11 is turned on, the microprocessor 22 accepts registration of a reference subject to a library from the user via the switch group 22a and the touch panel 25a.

In this case, the user can choose from the following ways of registration.

(1) First, the user appropriately selects, for reproduction and display, image data including the reference subject from an image data group which is recorded in the memory card 21. While viewing the display, the user operates the touch panel 25a or the multi-selector button to specify, through inputs, an area of the reference subject in the monitor screen as an image for registration. Note that the electronic camera 11 may be provided with gaze point inputting mechanism so that the user can specify the area of the reference subject using it.

(2) The user chooses the type of the reference subject (human figure, face or the like) by menu selection. The microprocessor 22 extracts the reference subject in the image area in accordance with the chosen type by using an extraction method which is determined in advance according to the type of the reference subject (for example, known facial-recognition technology when the selected type of the reference subject is a face), and defines the image of an area including an extracted area (area of the reference subject) as the image of the reference subject for registration.

Step S1: The image analysis unit 19a finds mean values of hue H, saturation S, and lightness L of the registered image of the reference subject. Further, the image analysis unit 19a performs a histogram analysis of the registered image to find mode values of the hue H, saturation S, and lightness L (that is, the values of the largest area in the area of the reference subject).

The microprocessor 22 records the registered image of the reference subject and the above six values (hereinafter referred to as characteristic values) on the memory card 21 via the card interface 20. Registration library of the reference subject is generated in the memory card 21 through such processing.

Step S2: When the user switches a mode of the electronic camera 11 to a shooting mode, the microprocessor 22 determines that the library registration of the reference subject is complete, and moves its operation to a step S3. In other cases, the microprocessor 22 returns its operation to the step S0 to accept another specification of the reference subject from the user.

Step S3: Hereinafter, moving image shooting is started. That is, the microprocessor 22 gives the image sensor 13 a drive pulse for interleave read via the timing generator 22b. As a result of this, frames of moving image data (draft images by the interleave read in this case) are read from the image sensor 13 at the predetermined frame rate.

Step S4: Immediately after the start of the moving image data shooting, or when the reference subject is missing in the frame, the microprocessor 22 moves its operation to a step S5. Meanwhile, during the tracking of the reference subject through the frames of the moving image data, the microprocessor 22 moves its operation to a step S7.

Step S5: The subject extracting unit 19b regards the current frame of the moving image data as a search range, and searches a specific area similar to the reference subject in the range. A pattern matching method (sequential similarity detection algorithm, for example) may be used for such image searching.

According to such a method, it is possible to associate the registered reference subject image area with the area corresponding to the reference subject image in the current frame of the moving image data even with differences in slight the lightness, color and the like.

The subject extracting unit 19b may judge as a preliminary examination whether the color peculiar to the registered image of the reference subject (color with low frequency of occurrence in the general image, for example, flesh color in the landscape scene) is present or not in the current frame of the moving image. Such a preliminary examination realizes an easy and high-speed test to identify which one of the reference subjects registered in the library is present in the image area.

Additionally, this preliminary examination makes it possible to roughly know the position at which the reference subject is located in the current frame and to limit the search range. By starting the pattern matching from this roughly known position, it is possible to search the specific area similar to the reference subject in a short period of time.

Step S6: The image analysis unit 19a finds the six characteristic values (the mean values of the hue H, saturation S, and lightness L, and the mode values of the hue H, saturation S, and lightness L) of the specific area which is similar to the reference subject.

The image analysis unit 19a finds the differences between the characteristic values of the specific area and the characteristic values of the registered image, and judges whether they are within an allowance in which the specific area and the registered image are visually identical to each other.

When the differences in the characteristic values are beyond the allowance, the image analysis unit 19a decides a parameter for color adjustment (for example, hue adjustment, saturation adjustment, lightness adjustment) for reducing the differences in the characteristic values and transmits it to the image processing unit 19.

This parameter can be one for preferentially reducing the differences in the mean values and one for preferentially reducing the differences in the mode values. It is preferable that the user sets in advance which parameter to be adopted by custom setting.

The image processing unit 19 uses the parameter which is transmitted from the image analysis unit 19a to apply the color adjustment to the specific area in the current frame.

When the color adjustment of the current frame is complete, the microprocessor 22 moves its operation to a step S9.

Step S7: In this step, the reference subject is successfully found in the immediately preceding frame of the moving image data. Therefore, the specific area similar to the reference subject is searched from the current frame by narrowing the search area to the vicinity of the position of the reference subject in the immediately preceding frame. The pattern matching method (sequential similarity detection algorithm, for example) may be also used for such image searching.

Step S8: The image analysis unit 19a finds the characteristic values (the mean values of the hue H, saturation S, and lightness L, and the mode values of the hue H, saturation S, and lightness L) of the specific area which is similar to the reference subject.

The image analysis unit 19a finds the differences in the characteristic values between the immediately preceding frame and the current frame, and judges whether or not they are within the allowance in which the immediately preceding frame and the current frame are visually identical to each other.

When the differences in the characteristic values are beyond the allowance, the image analysis unit 19a decides the parameter for the color adjustment (for example, the hue adjustment, saturation adjustment, lightness adjustment) for reducing the differences in the characteristic values and transmits it to the image processing unit 19.

It is possible to preferentially choose the mean values or the mode values among the characteristic values to be approximated in this case as well.

The image processing unit 19 uses the decided parameter to apply the color adjustment to the specific area in the current frame.

When the color adjustment of the current frame is complete, the microprocessor 22 moves its operation to the step S9.

Step S9: The image display unit 24 displays on the monitor the current frame on which the processing such as the color adjustment is performed.

Step S10: The microprocessor 22 judges whether the user gives an instruction to record the moving image via the switch group 22a or not.

When the instruction to record the moving image is given, the microprocessor 22 moves its operation to a step S11.

Meanwhile, when the instruction to stop recording the moving image is given, the microprocessor 22 moves its operation to a step S12.

When the instruction to record the moving image is not given, the microprocessor 22 moves its operation to a step 513 without performing the recording processing on the moving image data.

Step S11: After the instruction to record the moving image from the user, the microprocessor 22 applies compression processing to the moving image data of the current frame in the buffer memory 17, to which the processing such as the color adjustment is performed. Frame data in a moving image file (Motion JPEG, MPEG and the like) is generated by the compression processing and stored in the buffer memory 17. After the processing, the microprocessor 22 moves its operation to a step S13.

The card interface 20 sequentially performs the writing to the memory card 21 every time the successively generated moving files are accumulated to a predetermined writing amount.

Step S12: In this step, the generation of the moving image file is complete according to the stop processing of the moving image recording.

The microprocessor 22 attaches any of the following as an index in association with the moving image file for records:

(1) the registered image of the reference subject;

(2) the image of the specific area in the representative frame (first frame, for example); and

(3) the information on the position of the specific area in the image area of the representative frame.

After this processing, the microprocessor 22 moves its operation to the step S13.

Step S13: Here, the microprocessor 22 judges whether release operation to record a still image is given by the user via the switch group 22a or not.

With the release operation to record the still image, the microprocessor 22 moves its operation to a step S14.

Meanwhile, without the release operation to record the still image, the microprocessor 22 returns its operation to the step S3 and continues to shoot the moving image data.

Step S14: The microprocessor 22 gives the image sensor 13 a drive pulse for reading the still image via the timing generator 22b. As a result of this, still image data (high resolution image by total pixel read in this case) is read from the image sensor 13 at the predetermined frame rate.

Step S15: Here, the microprocessor 22 judges whether the tracking of the reference subject has been continued up to then or not.

When the tracking has been continued, the microprocessor 22 moves its operation to a step S18.

Meanwhile, when the reference subject is not being tracked, for example when it is missing therefrom, the microprocessor 22 moves its operation to a step S16.

Step S16: The subject extracting unit 19b regards all the area of the still image data (or a preview image in which the resolution of the still image data is reduced) as the search range, and searches the specific area which is similar to the reference subject. The pattern matching method (sequential similarity detection algorithm, for example) may be used for such image searching.

The subject extracting unit 19b may judge whether the color peculiar to the registered image of the reference subject (color with low frequency of occurrence in the general image) is present or not in the still image data as the preliminary examination. Such a preliminary examination realizes an easy and high-speed test to identify which one of the reference subjects registered in the library is present in the image area.

Additionally, this preliminary examination makes it possible to roughly know the position at which reference subject is located in the still image data. By starting the pattern matching from this roughly known position, it is possible to search the specific area similar to the reference subject in a short period of time.

Step S17: The image analysis unit 19a finds the six characteristic values (the mean values of the hue H, saturation S, and lightness L, and the mode values of the hue H, saturation S, and lightness L) of the specific area similar to the reference subject, which is obtained by the searching in the step S16.

The image analysis unit 19a finds the differences between the characteristic values of the specific area and the characteristic values of the registered image, and judges whether or not they are within the allowance in which the specific area and the registered image are visually identical to each other.

When the differences in the characteristic values are beyond the allowance, the image analysis unit 19a decides the parameter for the color adjustment (for example, hue adjustment, saturation adjustment, lightness adjustment) for reducing the differences in the characteristic values and transmits it to the image processing unit 19.

In this case, it is possible to choose either the parameter for preferentially reducing the differences in the mean values or the parameter for preferentially reducing the differences in the mode values by the custom setting.

The image processing unit 19 uses the chosen parameter to apply the color adjustment to the specific area in the still image data.

When the color adjustment of the still image data is complete, the microprocessor 22 moves its operation to a step S21.

Step S18: In this step, the reference subject is successfully searched to the last minute. Therefore, the subject extracting unit 19b estimates the position of the reference subject at the time of shooting the still image data from the position of the reference subject in the captured image area and its moving path.

Step S19: The subject extracting unit 19b narrows the search range to the vicinity of the estimated position of the reference subject. Then, the subject extracting unit 19b searches the specific area which is similar to the reference subject from the still image data (or the preview image in which the resolution of the still image data is reduced). The pattern matching method (sequential similarity detection algorithm, for example) may be used for such image searching.

Step S20: The image analysis unit 19a finds the six characteristic values (the mean values of the hue H, saturation S, and lightness L, and the mode values of the hue H, saturation S, and lightness L) of the specific area which is similar to the reference subject.

The image analysis unit 19a finds the differences in the characteristic values between the immediately preceding frame and the current frame, and judges whether or not they are within the allowance in which the immediately preceding frame and the current frame are visually identical to each other.

When the differences in the characteristic values are beyond the allowance, the image analysis unit 19a decides the parameter for the color adjustment (for example, hue adjustment, saturation adjustment, lightness adjustment) for reducing the differences in the characteristic values and transmits it to the image processing unit 19.

In this case, it is also possible to choose in advance either the mean values or the mode values to be approximated by the custom setting.

The image processing unit 19 uses the decided parameter to apply the color adjustment to the specific area in the still image data.

When the color adjustment like this is complete, the microprocessor 22 moves its operation to the step S21.

Step S21: The image display unit 24 displays on the monitor screen 25 the still image data to which the processing such as the color adjustment is given as a preview.

Step S22: The compression/decompression unit 23 applies image compression to the still image data to which the processing such as the color adjustment is given, to generate a still image compressed file.

The card interface 20 records this still image compressed file on the memory card 21.

Meanwhile, the microprocessor 22 attaches and records any of the following as an index in association with the still image compressed file in the memory card 21:

(1) the registered image of the reference subject;

(2) the image of the specific area in the still image data; and

(3) the information on the position of the specific area in the image area of the still image data.

Step S23: Here, the microprocessor 22 judges whether the electronic camera 11 is set to a continuous shooting mode or not.

In the case of a single exposure mode, the microprocessor 22 finishes the still image shooting and returns its operation to the step S3.

When it is set to the continuous shooting mode and the release button is pressed continuously, the microprocessor 22 returns its operation to the step 14 and continues the still image shooting.

Meanwhile, when it is set to the continuous shooting mode and the pressing of the release button is released, the microprocessor 22 finishes the continuous shooting operation of the still image data and returns its operation to the step S3.

By the sequential operation explained thus far, it is possible for this embodiment to improve an unnatural phenomenon in which the color of the reference subject changes suddenly in both of the moving image data and the still image data.

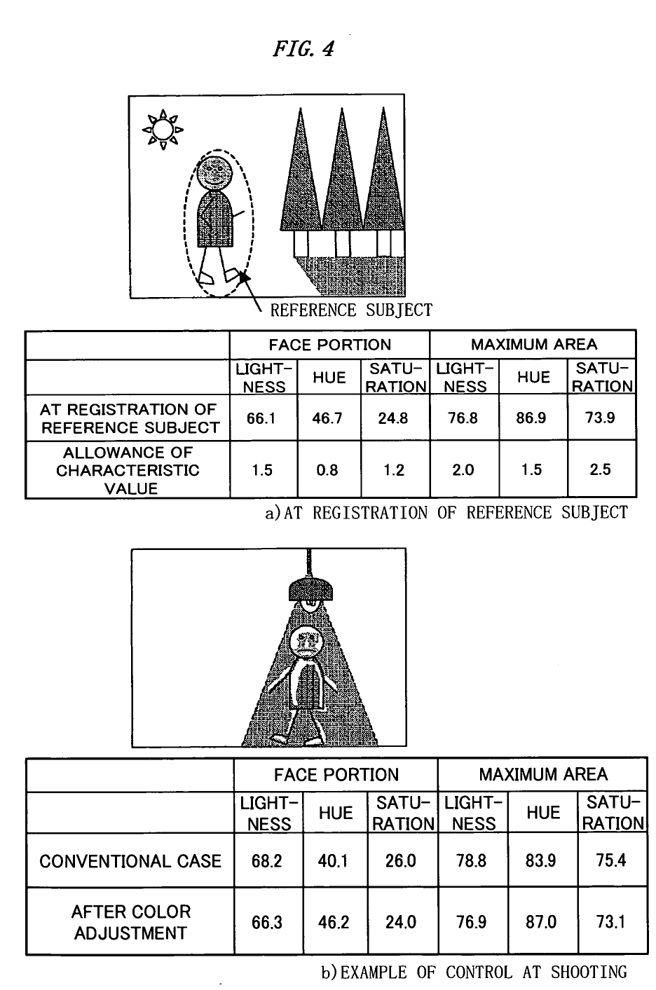

FIG. 4 are views explaining the specific effect of this embodiment. In this case, the example in which the entire human figure under fine weather is registered is explained. FIG. 4(a) shows the respective characteristic values at the time when the reference subject is registered, and the allowances for the visual identity for the respective characteristic values.

The explanation given here is about the case where the mean values of the hue H, saturation S, and lightness L are determined in the area of the face which is extracted using the facial-recognition technology or the like in particular, and the mode values of the hue H, saturation S, and lightness L are determined in the area of clothes of the registered reference subject being extracted.

Thus, the mean values of the hue H, saturation S, and lightness L in a part of the area in the specific area may be determined.

The lightness L in FIG. 4 is given as an L*-value when the image is represented in a CIE-LAB color system. L=0 represents the darkest state (black), and L=100 represents the brightest state (white). Further, the hue H is given by the expression 1 based on a*- and b*-values when represented in the CIE-LAB color system, and takes the value from 0 to 360°. It corresponds to magenta when the value is 0°, changes to red, orange, yellowish green and green as the value increases, corresponds to blue-green when the value is 180°, changes to cyan, blue and purple as the value increases, and returns to magenta again when the value is 0°.
H=tan θ(b*/a*) (where tan θ(b*/a*)≧0)
H=tan θ(b*/a*)+360° (where tan θ(b*/a*)<0) Expression 1

Further, the saturation S is given by the expression 2 based on the a*- and b*-values when represented in the CIE-LAB color system. S=0 represents the state with the lowest saturation and S=100 represents the state with the highest saturation.
S=√(a*2+b*2) Expression 2

FIG. 4(b) shows the example where the shooting scene changes and the color adjustment is applied to the human figure (reference subject) under bulb illumination. Since the illumination changes from when the reference subject is registered, the hue in the area of the flesh shifts to yellow and red, and the hue in the area of the mode value (clothes part) also shifts to yellow and orange, when the color adjustment is not applied thereto.

Meanwhile, the respective characteristic values of the image data after the color adjustment are adjusted to be within the allowances shown in FIG. 4(a) in both of the face area and the clothes area, and they are within the range in which it is seen visually the same as the registered reference subject.

By the color adjustment processing described above, it is possible to securely prevent the color change of the reference subject due to color temperature unevenness in the image area.

The above-described registration of the reference subject and the photographing based on the registered reference subject do not need to be performed temporally consecutively. That is, a photographer may register in the library the reference subject from the image which has already been shot in advance and when, for example, shooting another day, he/she may adjust the color of the subject according to the reference subject in the shot image to be visually the same as the color of the registered reference subject.

Moreover, the above-described embodiment has described the example of the imaging device in which the reference subject is registered in the library in advance and the specific area similar to the registered reference subject is searched in captured data.

However, it may be so structured that a plurality of the reference subjects are registered in the library to choose a desired reference subject from them with the switch group 22a, the touch panel 25a or the like as necessary.

Furthermore, the above-described embodiment has described the example of searching the specific area similar to the reference subject which is registered in advance from the image data obtained by the shooting. However, it may be structured as a reproducing device which searches the specific area similar to the reference subject which is registered in advance from the recorded image data.

(Effect and the Like of this Embodiment)

Hereinafter, the effect of this embodiment will be explained.

(1) The electronic camera 11 of this embodiment first searches the specific area which is similar to the reference subject from the image area of the captured image data. The electronic camera 11 applies the color adjustment to the image data so that the color information of the specific area comes closer to the ideal color information of the registered reference subject.

As a result of this, it is possible to obtain stable color reproduction of the reference subject which is registered in advance, irrespective of the color temperature unevenness in the image area.

(2) When the color of the subject changes suddenly between the frames in shooting the moving image data, the image looks unnatural. Therefore, it is preferable to perform the following operation in shooting the moving image data according to this embodiment.

First, the found specific area is tracked through the frames of the moving image data. The color adjustment is applied to the frames of the moving image data so that the color information of the specific area tracked does not change beyond the visually allowable range between the frames.

As a result of this, it is possible to improve the unnaturalness in which the color reproduction of the reference subject changes suddenly in the middle of the moving image.

(3) Further, the electronic camera 11 may generate the moving image data for the monitor display and generate the still image according to the release operation from the user.

Therefore, it is preferable that, when the moving image data for the monitor display is generated, the specific area is tracked using the moving image data for the monitor display, and the specific area of the still image data is estimated from the result of the tracking. This estimation allows the position of the reference subject to be limited more precisely even when, for example, the reference subject is moving at a high speed (for example, a bird, an automobile and the like).

Hence, it is possible to find the range of the reference subject (specific area) promptly and precisely even when the release operation is sudden, and to obtain the stable color reproduction of the reference subject which is registered in advance.

(4) When the color adjustment is performed placing emphasis on the reference subject, the color of an area whose color is not supposed to change, such as a background portion, also changes due to a side effect of the color adjustment.

Therefore, according to the present invention, it is preferable that the above-described color adjustment is partially applied to the specific area. In this case, it is possible to prevent the side effect of the color adjustment to the area other than the specific area (background portion, for example) while stabilizing the color reproduction of the reference subject.

(5) Additionally, according to this embodiment, it is preferable that the image of the reference subject is specified from the image data shot in an imaging unit. The registration method like this eliminates the trouble of inputting a specific parameter for the reference subject (representative color, for example). As a result of this, it is possible for the user to complete the registration of the reference subject quickly.

(6) According to this embodiment, it is preferable that the registered data of the reference subject is stored in the form of the library.

Using such an electronic camera 11, it is possible to register in the library the reference subjects (for example, every member of the family) which are often shot by the user in advance. This can eliminate the trouble of registering the same reference subject every time the user photographs, thereby realizing the handy device.

(7) Moreover, according to this embodiment, it is preferable that any of the image of the reference subject, the image of the specific area and the information on the position of the specific area in the image area is recorded as the index for the image data to be recorded.

The image of the reference subject and the image of the specific area can be used later as the index images clearly showing the contents of the image data.

Further, when the information on the position of the specific area in the image area is recorded, it is possible to extract the specific area from the image data and use it later as the index image. Furthermore, since the information on the position of the specific area in the image area has a smaller data amount as compared to the index image, it has a secondary effect that the recording capacity can be saved.

As all the above-described information for the index purpose, the ones already found in the course of the color adjustment in this embodiment can be secondarily used. Therefore, the above structure is remarkably excellent in that the processing cost for generating the index does not newly occur even though the index is added to the recorded image.

(Supplementary Items of this Embodiment)

According to this embodiment, the color adjustment is performed based on the characteristic values consisting of the hue H, saturation S, and lightness L. However, the embodiment is not limited to the above. For example, the color adjustment may be performed based on the other color systems such as an RGB value, XYZ value, Lab value and so on.

Moreover, according to this embodiment, it is preferable to perform image processing such as smoothing and space differentiation prior to the determination of the characteristic values. The smoothing can reduce the influence of a fine pattern on the characteristic values. Further, when the space differentiation is performed, it is possible to find the characteristic values placing emphasis on a portion with a large spatial change of the image.

According to this embodiment, description is given only on the operation explanation of the color adjustment processing for simplicity. However, the present invention is not limited to the above. The above-described color adjustment processing may be performed together with white balance adjustment, color system conversion (conversion from RGB to YCbCr), color interpolation and the like.

Moreover, according to this embodiment, when the tracking of the reference subject is started, the color adjustment is performed so that the characteristic values of the latest image data approximate to the characteristic values of the image data shot immediately before (step S8, step S20). This operation allows the color of the reference subject to approximate to the color of the registered image and the color of the reference subject to change gradually.

However, this embodiment is not limited to the above. For example, the color adjustment may be performed so that the characteristic values of the latest image data approximate to the characteristic values of the original registered image.

Further, according to this embodiment, the explanation is given on the case where the captured moving image is used for the monitor display. However, this embodiment is not limited to the above. The moving image, as well as the still image, may be recorded on the recording medium such as the memory card 21.

According to this embodiment, the explanation is given on the case where all of the operations of the invention are performed inside the electronic camera 11. However, this embodiment is not limited to the above. For example, the recorded image data may be taken in the computer, and the color adjustment according to this embodiment may be performed by software processing of the computer.

The invention is not limited to the above embodiments and various modifications may be made without departing from the spirit and scope of the invention. Any improvement may be made in part or all of the components.

What is claimed is:

1. An imaging device comprising:
an imaging unit shooting a subject and outputting image data;
a searching unit searching, from an image area of the image data, a specific area similar to a reference subject which is registered in advance; and
a color adjustment unit applying color adjustment to the image data in such a manner that color information of the specific area approximates to color information of the registered reference subject.

2. The imaging device according to claim 1, wherein:
said imaging unit shoots a subject at a predetermined frame rate and outputs moving image data;
said searching unit tracks a found specific area through frames of the moving image data; and
said color adjustment unit applies the color adjustment to the frames of the moving image data so that the color information of the specific area does not change among the frames beyond a visually allowable range.

3. The imaging device according to claim 1, wherein:
said imaging unit outputs moving image data for monitor display and still image data for recording, the moving image data for monitor display being captured at a predetermined frame rate, the still image data being shot in synchronization with release operation;
said searching unit searches the specific area from the moving image data and tracks the specific area through frames of the moving image data, to thereby estimate the specific area of the still image data; and
said color adjustment unit obtains color information of the estimated specific area from the still image data or the moving image data, and applies the color adjustment to the still image data in such a manner that the obtained color information of the specific area approximates to the color information of the registered reference subject.

4. The imaging device according to claim 1, wherein
said color adjustment unit applies the color adjustment partially to the specific area.

5. The imaging device according to claim 1, wherein
said searching unit includes a registration unit registering the reference subject upon receiving designation of an image of the reference subject among the image data shot by said imaging unit, and searches the specific area similar to the image of the reference subject.

6. The imaging device according to claim 1, wherein:
said searching unit includes a registration unit managing a registration library of the reference subject, and searches the specific area similar to the reference subject from the image area of the image data by reading registration information of the reference subject from the registration library; and
when the specific area is found, said color adjustment unit applies the color adjustment to the image data in such a manner that the color information of the specific area approximates to the color information of the registered reference subject.

7. The imaging device according to claim 1, further comprising
a recording unit recording the image data, wherein:
said recording unit records, as an index of the image data to be recorded, any of an image of the reference subject, an image of the specific area and information on a position of the specific area in the image area.
